(19) United States
(12) Patent Application Publication
(10) Pub. No.: US 2012/0012184 A1
(43) Pub. Date: Jan. 19, 2012

(54) DEVICE AND METHOD FOR PROVIDING A LIQUID PRODUCT TO BE REUSED AND TO BE TREATED

(75) Inventors: JURGEN MUHLBAUER, Duggendorf (DE); DIRK RECKTENWALD, Bad Abbach (DE)

(73) Assignee: KRONES AG, Neutraubling (DE)

(21) Appl. No.: 13/181,704

(22) Filed: Jul. 13, 2011

(30) Foreign Application Priority Data
Jul. 16, 2010 (DE) 102010031478.1

(51) Int. Cl. F15D 1/00

(52) U.S. Cl. 137/1; 137/561 R

(57) ABSTRACT

A device and a method for providing a liquid product to be treated and reused, including a by-pass through which untreated product can be fed into a supply pipe on the outlet side while a supply tank is bypassed, allowing mixing of already treated product stored in the supply tank with the untreated product such that the mixed product can be supplied to a treatment again.

### CROSS-REFERENCE TO RELATED APPLICATION

The present application claims the benefit of priority of German Application No. 102010031478.1, filed Jul. 16, 2010. The entire text of the priority application is incorporated herein by reference in its entirety.

### FIELD OF THE DISCLOSURE

The disclosure relates to a device and to a method for the reuse and treatment of a liquid product, such as a food product.

### BACKGROUND

Before readily mixed products, such as e.g. juice drinks, are filled, they are normally intermediately stored in a supply tank and subjected to a treatment, for example to a heat treatment or degassing. During a production-related standstill of the filling process, the product must not stand in the treatment systems but must then be either circulated, supplied to a collection container for recovering the treated product, or be disposed of.

To be able to reuse treated product observing a required minimum quality, it is well-known from prior art to first collect treated product in a collecting vessel during a standstill of a filling unit, and when operation is restarted, admix it to a product flow of untreated product at a defined mixing ratio. The product mixed in this manner is then lead into a supply tank of the treatment unit and subsequently treated therein. The treated product can then be finally filled.

It is, however, a disadvantage of this method that the above mentioned separate collecting vessel is required, resulting in considerable costs for material, construction, assembly and commissioning. Moreover, an increased space requirement in the filling pipe must be accepted.

### SUMMARY OF THE DISCLOSURE

It is an aspect of the disclosure to mitigate or overcome the above-described disadvantages.

As one can feed untreated product into the supply pipe on the side of the outlet through a by-pass bypassing the supply tank, with the present device it is possible to mix treated product intermediately stored in the supply tank with untreated product in the supply pipe.

However, in the supply tank, a mixture of treated and untreated product could also be intermediately stored. The product to be filled is preferably a readily mixed beverage. However, the product could also be a different fluid, such as free-flowing medicine. The supply tank can also be used to intermediately store untreated product, in particular if there is no treated product to be returned. This is the case, for example, after the system has been started, before a standstill occurs for the first time during filling.

A particularly advantageous embodiment of the device according to the disclosure comprises a flow adjustor for adjusting the volume flow rate through the by-pass. Thereby, a predetermined quantity of the untreated product can be admixed to the product flowing out of the supply tank to provide a product quality suited for a subsequent treatment in the mixture, in particular a maximally admissible proportion of already treated product. In addition to this, it would also be possible to provide another flow adjustor for adjusting the volume flow rate of the intermediately stored product which is lead out of the supply tank.

A particularly advantageous embodiment of the device furthermore comprises a flow sensor or meter on the inlet side for measuring the volume flow rate through the supply pipe on the inlet side. Thereby, the volume flow rate of untreated product in the direction to the supply tank or into the by-pass can be alternatively determined. Thus, only one single flow sensor is required to selectively measure the volumetric flow rate of the untreated product in the direction to the supply tank and into the by-pass.

Preferably, the device according to the disclosure furthermore comprises a flow sensor or meter on the outlet side for measuring the volume flow rate through the supply pipe on the outlet side. Thereby, the volumetric flow rate in the supply pipe on the outlet side can be measured to selectively measure the volume flow rate of untreated product or a mixture of untreated product and treated product. In particular in connection with a flow sensor on the inlet side in the supply pipe on the inlet side, a mixing ratio of the untreated product flowing through the bypass to the intermediately stored product which is lead out of the supply tank can be calculated with the flow sensor on the outlet side. Thus, one cannot only determine the volumetric flow rate of a product to be treated flowing away in the direction to a following treatment unit, but also the mixing ratio when treated product is returned.

A particularly advantageous embodiment of the device according to the disclosure furthermore comprises a control unit which is designed such that it can adjust a mixing ratio of the intermediately stored product to the product supplied through the by-pass in the supply pipe on the outlet side by means of controlling the flow adjustor on the basis of measuring signals of the flow sensor on the inlet side and the outlet side. Thereby, the mixing ratio can be continuously adjusted and controlled by actuating an actuating unit with only two process variables. Thus, a required minimum quality of the product to be treated can be ensured. Here, one can in particular avoid that the proportion of already treated product exceeds a predetermined maximum value when it is supplied to the treatment unit.

Preferably, the by-pass branches off from the supply pipe on the inlet side in the direction of flow downstream of the flow sensor on the inlet side. Thereby, the section of the supply pipe on the inlet side with the flow sensor on the inlet side can be used for measuring the volume flow rate in the direction to the supply tank as well as into the by-pass.

The aspect is furthermore achieved with a device for treating a liquid product, comprising the device according to the disclosure and a treatment unit, where the capacity of the supply tank is at least as high as the total capacity of the return pipe, the treatment unit and a connection pipe connecting the treatment unit and the return pipe, in particular including the capacity of a filler machine inserted between the return pipe and the connection pipe. It is thereby possible to return the complete product contents of the treatment system into the supply tank and supply it to a later new treatment in case of a standstill of the bottling plant or an end of the filling process.

By the untreated product being fed into the supply pipe on the outlet side through a by-pass bypassing the supply tank, it is possible with the present method both to lead untreated product into a subsequent treatment unit without mixing it with treated product, and to mix untreated product with treated product. The supply tank can therefore fulfill a mere supply function, i.e. untreated product is lead into the supply tank, intermediately stored therein and subsequently lead again out of the supply tank and supplied to a treatment. However, the supply tank can also fulfill the function of a collecting vessel for treated product to be reused, making an additional collecting vessel dispensable. It is also possible to intermediately store a predetermined mixture of treated and untreated product in the supply tank and mix it at a predetermined mixing ratio with the fresh product supplied through the by-pass. It is also possible to exclusively supply already treated product from the supply tank to the treatment unit if no more untreated product is available. If for example no more fresh product is available at the end of production, one can use 100% of already treated product until the end.

Preferably, the method according to the disclosure furthermore comprises a step d) in which the intermediately stored product discharged in step b) as a first partial product flow, and the untreated product introduced in step c) as a second partial product flow are combined to one product flow and forwarded to the treatment of the product. Thereby, already treated product can be mixed with untreated product such that the mixed product flow is suited for a subsequent treatment. Such a treatment can e.g. be a heat treatment or a degassing of the product. Thus, the supply pipe on the outlet side can be used as a mixing means to establish a mixing ratio of treated and untreated product suited for the treatment.

Preferably, the volumetric flow rate of the second partial product flow is determined by measuring a volume flow rate through a supply pipe on the inlet side for introducing untreated product into the supply tank. Such a procedure makes an additional flow sensor in the by-pass dispensable. Thereby, not only the number of required flow sensors, but also the number of measuring signals to be processed in a control unit can be reduced.

In a particularly advantageous embodiment of the method according to the disclosure, the volume flow rate of the product flow in the supply pipe on the outlet side is measured, and the mixing ratio of the first and the second partial product flow is adjusted by adapting the proportion of the first partial product flow to the product flow. It is therefore not necessary to measure the volumetric flow rate of the intermediately stored product flowing out of the supply tank. The number of required measuring units and measuring signals can thus be reduced. However, it would also be possible to additionally measure the volume flow rate of the product flowing out of the supply tank.

Preferably, the method according to the disclosure furthermore comprises the following steps: f) detecting that a minimum filling level of the intermediately stored product in the supply tank is reached; g) introducing untreated product into the supply tank; and/or h) reducing the first partial product flow and adapting the volume flow rate of the second partial product flow to the product flow, or interrupting the first partial product flow and adjusting the volume flow rate of the second partial product flow to the product flow. It is thereby possible to change from a mixing operation to a mere supply operation without interrupting the product flow. Here, a mixing operation is defined as a condition in which untreated product from the by-pass is mixed with intermediately stored product from the supply tank. On the other hand, a supply operation is defined as a condition in which only untreated product is lead through the by-pass and/or through the supply tank and supplied to a subsequent treatment. It would thus also be possible to lead a partial flow of the untreated product through the by-pass and to lead a further partial flow of the untreated product through the supply tank.

Preferably, the water contents of the intermediately stored product discharged in step b) and the untreated product introduced in step c) are identical. Thus, both the untreated product and the treated product are a readily mixed product of which the recipe does not change during the mixing in the supply pipe on the outlet side and/or in the supply tank. Thereby, a repeated recovery of already treated product is also possible, as long as a given range of the mixing ratio of untreated and treated product is observed.

Preferably, step a) of returning treated product to be reused into a supply tank and intermediately storing the product there is carried out during or as a consequence of a standstill of a filling machine for filling the treated product. The method according to the disclosure can be combined with a filling machine in a particularly advantageous manner to compensate repeated production-related standstill phases of filling.

In a particularly advantageous embodiment of the method according to the disclosure, the product is circulated during the standstill of the filling machine including steps a) and b). Thereby, in particular short-term standstill phases of filling can be bridged by keeping the product in motion, and not having it dwell in the treatment units for an inadmissibly long period. For example in thermal treatment processes, an overheating of the product can be avoided.

### BRIEF DESCRIPTION OF THE DRAWINGS

A preferred embodiment of the device according to the disclosure is represented in the drawing. The single FIGURE shows a diagram of the device according to the disclosure with the corresponding product flows.

### DETAILED DESCRIPTION OF THE PREFERRED EMBODIMENT

Accordingly, the device 1 according to the disclosure comprises, for the provision of a liquid product 2, such as for example a beverage, in particular a beverage to be treated with heat, a supply tank 3 with a supply pipe 5 on the inlet side and a supply pipe 7 on the outlet side which can be connected to a subsequent heat treatment unit 9. A return pipe 11 which can be connected, for example, with a filling machine 12 is also represented. Furthermore, a bridging pipe 13 is provided at the supply tank 3 and connected, for example, with the supply pipe 5 on the inlet side and the supply pipe 7 on the outlet side. To adjust the volume flow rate through the by-pass 13, an adjustor 15, such as a control valve, is provided at the latter.

The supply pipe 5 on the inlet side serves to feed an untreated product 2 into the supply tank 3 and/or into the by-pass 13. To be able to adjust the volumetric flow rate VV of the untreated product 2 into the supply tank 3 independent of the volumetric flow rate VU through the by-pass 13, a flow adjustor 21 is provided at the supply pipe 5 on the inlet side downstream of a branch 19 of the by-pass 13 from the supply pipe 5 on the inlet side. This could be, for example, a controllable valve.

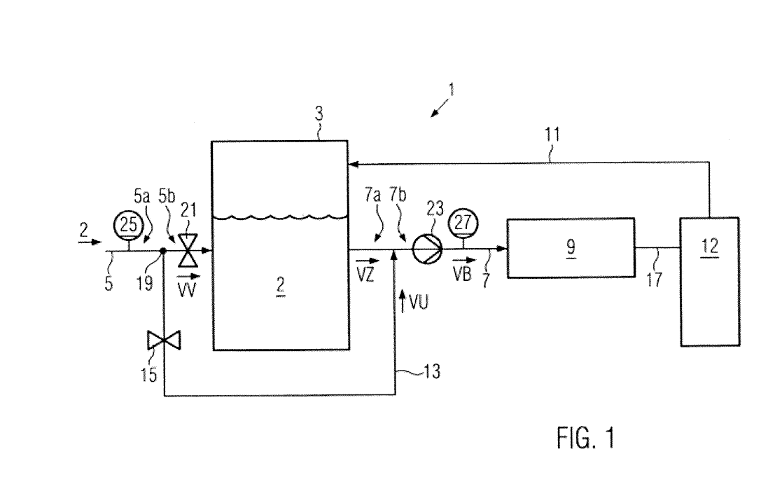

In FIG. 1, a supply pump 23 for delivering the product 2 from the supply pipe 7 on the outlet side in the direction to the treatment unit 9 is furthermore indicated. To measure a volume or mass flow of the product 2, there are furthermore provided a flow sensor or a flow meter 25 at the supply pipe 5 on the inlet side, and a flow sensor or a flow meter 27 at the supply pipe 7 on the outlet side. These are, just as the flow adjustor 15, connected with a not represented control unit.

As can be moreover seen in FIG. 1, in particular by the direction of flow in the pipes 5, 7, 11 and 13 indicated by the arrowheads, the supply tank 3 can be filled with untreated product 2 through the supply pipe 5 on the inlet side, as well as with treated product 2 through the return pipe 11. Therefore, the return pipe 11 may not only be connected to the filling unit 12, but for example also to the treatment unit 9. It is thus, depending on the operating state, possible that the supply tank 3 contains exclusively untreated product 2, exclusively treated product 2, or a mixture of treated and untreated product 2. In contrast to this, the by-pass 13 exclusively carries untreated product 2.

The supply pipe 5 on the inlet side is divided into a section 5a upstream of the branch 19 and a section 5b downstream of the branch 19. The flow meter 25 is preferably arranged in the section 5a, so that it can be employed for measuring the flow of the untreated product 2 in the direction to the supply tank 3 as well as in the direction to the by-pass 13.

The supply pipe 7 on the outlet side is divided into a section 7a upstream of the junction with the by-pass 13 and a section 7b downstream of the junction with the by-pass 13. The flow meter 27 is arranged in the section 7b such that the volume flow rate of the product flow VB to be supplied to the heat treatment 9 can be measured independent of the proportions of the partial product flow VZ of the intermediately stored product 2 and the partial product flow VU lead through the by-pass 13, which proportions constitute the product flow VB.

In an operating state for recovering and admixing already treated product 2, at least some of the product in the supply tank 3 is treated product 2. To supply this intermediately stored product 2 again to the treatment, the volume flow rate of the partial product flow VU of the untreated product 2 is adjusted such that, together with the partial product flow VZ of the product 2 flowing out of the supply tank, a predetermined volume flow rate of the product flow VB of the product 2 to be treated results, where simultaneously a minimum proportion of untreated product 2 is maintained. To adjust a predetermined mixing ratio of the partial product flows VZ and VU in the product flow VB, it is sufficient to measure the volume flow rate through the supply pipe 5 on the inlet side with the flow meter 25 and to measure the volume flow rate through the supply pipe 7 on the outlet side with the flow meter 27. The volume flow rate through the section 7a of the supply pipe 7 on the outlet side can then be calculated from these measured quantities. That means the flow adjustor 15 controls the volume flow rate VU and the pump 23 controls the flow VB through the pipe section 7b. Thus, the exact control of the mixing ratio is possible. In addition, it would also be possible to provide an additional flow meter in section 7a of the supply pipe 7 on the outlet side.

The capacity of the supply tank 3 is preferably higher than the total volume of the supply pipe 7 on the outlet side, the heat treatment unit 9, a connection pipe 17 between the heat treatment unit 9 and the filling unit 12 as well as the return pipe 11. This ensures that the supply tank can accommodate the total product volume of the aforementioned units in case of a standstill of the filling unit 12. The supply tank 3 can also be designed such that it can additionally accommodate a predetermined product volume from the filling unit 12. Particularly advantageous is a design in which the supply tank 3 has at least twice the capacity of all pipes 7, 11, 17 connected to the supply tank 3, treatment units 9 and filling units 12 that can carry treated product 2. One can thus avoid that already treated product 2 must be rejected in case of a standstill of the filling unit 12. Such a dimensioning of the supply tank 3, however, is not imperative. It is decisive that already treated product 2 can be mixed with untreated product 2 without a separate collecting vessel for the treated product 2 and supplied to a treatment again.

One can work as follows with the device 1 according to the disclosure:

Before the filling of treated product 2 is started, untreated product 2 is for example continuously lead via the supply tank 3 and the supply pipe 7 on the outlet side into the heat treatment unit 9 and subsequently into the filling unit 12. Preferably, before filling is started, first the return pipe 11 is filled with the treated product 2, so that in case of a possible standstill of the filling unit 12, one can immediately begin with a return of the treated product 2. However, this is not imperative.

If there is no treated product 2 to be reused, for example before a first standstill of the filling unit 2, the untreated product 2 can be either lead through the supply tank 3 into the supply pipe 7 on the outlet side after the adjusting means 21 has been opened, or through the by-pass 13 after the adjusting means 15 has been opened. In both cases, the volume flow rate of the product 2 can be measured with the flow meters 25 and/or 27.

In case of a standstill of the filling unit 12, treated product 2 is returned through the return pipe 11 into the supply tank 3. Preferably, the product 2 is then circulated through the supply pipe 7 on the outlet side, the heat treatment unit 9 and the return pipe 11 to prevent the product 2 from dwelling in the heat treatment unit 9 for a longer time than admissible. Here, one can add untreated product 2 to the returned treated product 2 from the supply pipe 5 on the inlet side in the supply tank 3 to prevent an excessive repeated treatment of the product 2.

When the standstill of the filling unit 12 is terminated, untreated product 2 can first be introduced via the by-pass 13 into the supply pipe 7 on the outlet side and supplied to the treatment unit 9, so that the complete already treated product 2 is expelled through the return pipe 11 into the supply tank 3. If it is ensured that product 2 only treated once flows through the connection pipe 17 to the filling unit 12, already treated product 2 can be discharged from the supply tank 3 into the supply pipe 7 on the outlet side. Simultaneously, untreated product 2 is introduced into the supply pipe 7 on the outlet side via the by-pass 13 in a controlled manner and thus admixed to the intermediately stored product 2 from the supply tank 3 at a desired mixing ratio. Here, the volume flow rate or volumetric flow rate through the by-pass 13 is adjusted such that a minimum requirement on the quality of the mixed product flow VB is fulfilled after the treatment in the treatment unit 9. The admixture from the supply tank 3 is usually within a range of 2 to 110% (in case of a possible overload) of the production performance.

Such an operating state of mixing already treated product 2 to untreated product 2 can be maintained as long as sufficient treated product 2 is stored in the supply tank 3. If a predetermined minimum filling level is fallen below in the latter, one can change back, for example, to the operating state before the standstill of the filling unit 12.

However, it would also be possible to additionally admix untreated product 2 to a residual amount of treated product 2 left in the supply tank 3 through the supply pipe 5 on the inlet side and to adjust the mixing ratio of the partial product flows or partial volume flows VZ and VU such that a minimum requirement on the quality of the mixed product flow or volumetric flow rate VB is fulfilled. Such a procedure permits to reuse and fill the complete product 2 intermediately stored in the supply tank 3.

With the device 1 according to the disclosure, already treated product 2 can be economically recovered during a standstill of a filling unit 12 and supplied to a new treatment. Here, untreated product 2 can be flexibly mixed to the already treated product 2 at a desired mixing ratio. By means of the by-pass 13, a separate collecting vessel for already treated product 2 becomes dispensable. Here, various operating states can be realized with only little equipment and a simple control.

1. A device for providing a liquid product to be treated, in particular a beverage comprising:
a supply tank for intermediately storing the product;
a supply pipe on the outlet side for discharging the product from the supply tank and forwarding the product to its treatment;
a supply pipe on the inlet side for introducing untreated product into the supply tank; and
a return pipe for returning treated product into the supply tank; and
a by-pass through which untreated product can be fed into the supply pipe on the outlet side bypassing the supply tank.

2. The device according to claim 1, and a flow adjustor for adjusting the volume flow rate (VU) through the by-pass.

3. The device according to claim 1, and a flow sensor on the inlet side for measuring the volume flow rate (VV, VU) through the supply pipe on the inlet side.

4. The device according to claim 1, and a flow sensor on the outlet side for measuring the volume flow rate (VB) through the supply pipe on the outlet side.

5. The device according to claim 2, and a control unit which is designed such that it can adjust a mixing ratio in the supply pipe on the outlet side, formed by the product intermediately stored in the supply tank and the product fed through the by-pass, by means of controlling the flow adjustor on the basis of measuring signals of the flow sensors on the inlet side and on the outlet side.

6. The device according to claim 3, wherein the by-pass branches off from the supply pipe on the inlet side in the direction of flow downstream of the flow sensor on the inlet side.

7. The device for treating a liquid product, in particular a beverage, comprising the device according to claim 1, and a treatment unit, wherein the capacity of the supply tank is at least as high as the total capacity of the return pipe, the treatment unit (9) and a connecting pipe connecting the treatment unit and the return pipe.

8. A method of providing a liquid product to be treated, in particular a beverage, comprising:
a) returning treated product to be reused into a supply tank and intermediately storing the product there;
b) discharging the intermediately stored product from the supply tank into a supply pipe on the outlet side; and
c) introducing untreated product into the supply pipe on the outlet side through a by-pass bypassing the supply tank.

9. The method according to claim 8, and d) combining the intermediately stored product discharged in step b) as a first partial product flow (VZ), and the untreated product introduced in step c) as a second partial product flow (VU) to a product flow (VB) and forwarded for treating the product.

10. The method according to claim 9, and determining the volumetric flow rate of the second partial product flow (VU) by measuring a volume flow rate through a supply pipe on the inlet side for introducing untreated product into the supply tank.

11. The method according to claim 10, and measuring the volume flow rate of the product flow (VB) in the supply pipe on the outlet side, and adjusting the mixing ratio of the first and the second partial product flows (VZ, VU) by adapting the proportion of the second partial product flow (VU) to the product flow (VB).

12. The method according to claim 9, further comprising:
detecting that a minimum filling level of the intermediately stored product is reached in the supply tank;
g) introducing untreated product into the supply tank; and/or
h) reducing the first partial product flow (VZ) and adapting the volume flow rate of the second partial product flow (VU) to the product flow (VB), or interrupting the first partial product flow (VZ) and adjusting the volume flow rate of the second partial product flow (VU) to the product flow (VB).

13. The method according to claim 8, wherein the water contents of the intermediately stored product discharged in step b) and the untreated product introduced in step c) are identical.

14. The method according to claim 8, wherein step a) is carried out during or as a consequence of a standstill of a filling machine for filling the treated product.

15. The method according to claim 14, wherein the product is circulated during the standstill of the filling machine including steps a) and b).

16. The device according to claim 7, and including the capacity of a filler machine inserted between the return pipe and the connecting pipe.
